(19) United States
(12) Patent Application Publication
(10) Pub. No.: US 2002/0153449 A1
(43) Pub. Date: Oct. 24, 2002

(54) Flying disk shaped flying/space vehicle with the use of a new technic of thrust through the rolling of a wheel

(76) Inventor: Nikolaos C Hatzistelios, Pireas (GR)

Correspondence Address: BLACK LOWE & GRAHAM, 816 SECOND AVE., SEATTLE, WA, 98104, US

(21) Appl. No.: 10/089,908

(22) PCT Filed: Aug. 7, 2001
(86) PCT No.: PCT/GR01/00032

(30) Foreign Application Priority Data
Aug. 8, 2000 (GR) 20000100278

(51) Int. Cl. B64C 15/00; B64C 29/00

(52) U.S. Cl. 244/12.2

(57) ABSTRACT

This invention called airwheel, concerns of a flying disk shaped flying/space vehicle with the use of a new technic of thrust through the rolling of a wheel. If we exercise a force from a fixed point on the edge of a turning wheel (fixed related to the main body of the vehicle) and the direction of the force is opposite to the direction of the linear speed of the edge, then we will simulate the friction force between the turning wheel of a car and the road which forces the rolling of the car wheel and not just the revolving of it. The airwheel uses to roll (fly) a wheel named in the invention rolling wheel (b) and it embraces the main body (a) of the airwheel as well as an other wheel (Angular Momentum Maintenance Wheel (c)) which turns the other way around to maintain the angular momentum. The airwheel uses nozzles (k) to manoeuvre. Airwheel ingests atmospheric air to fly and avoids/standsup against air pockets using gas saved in a cylindric tank in it which diverts gas under great pressure to the nozzles. For the interplanetary flight airwheel uses the magnetic fields of the magnetosphere, magnetotail and the magnetic fields of solar wind. It comprises T-shaped telescopic devices which on the upper side of the “T” contain couples of superconductor bobbins.

### INTRODUCTION

This invention concerns of a new flying disk shaped flying/space vehicle which uses a new technic of thrust through the rolling of a wheel. This new vehicle using basic principles of the physics is able to travel with tremendous higher speeds than the speeds of the prior state of art flying vehicles, avoid/face air pockets, get back to the horizontal level from every slope as well as fly under every slope, change altitude and direction at will, land vertical and maintain a steady flight for the whole time of flight. For the shake of shortness from now on we will refer to this vehicle with the name “airwheel”.

### PRIOR STATE OF ART

The prior state of art consists of vehicles that use basically the lift force on wings (planes & helicopters) to maintain their height during the flight. This force in case of an air pocket or sudden winds could cause some flaws on the trajectory of the flight. Airwheel comes here to introduce a better way of steady flight through the use of air outflow and rotating wheels.

The prior state of art flying vehicles also use helicoid means which deal with the ‘pushing’ of air to get their thrust and thus they have some limitations in the speed they are able to achieve. Airwheel comes to introduce a new technic of thrust through the rolling of a wheel and the speeds airwheel is capable to achieve through the use of this new technic are limited only by the durability of the material the rolling wheel is constructed in distresses.

Helicopters are not able to fly under great slopes and achieve great speeds but are able to change the direction of flight as well as their flight height at will (in a rather short period of time & poly space) and at last are able to land vertical. On the other hand, airplanes are able to fly under great slopes (at least the fighters) with high speeds but are not able to change their flight height and direction at will (in a rather short period of time & poky space) and at last are not able to land vertical (except the harriers). Airwheel comes to fill an empty position, which will combine the good features of the helicopters & airplanes and add some new good features too. That's to say that airwheel is capable of travelling under every slope with tremendous higher speeds change flight height and direction at will (in a really short period of time & poky place) avoid & face air pockets, land vertical, and at last can be used as an interplanetary travel mean.

### DISCLOSURE OF THE INVENTION

This invention concerns of a new flying/space vehicle which maintains its height with the outflow of under great pressure gases and the use of lift due to the containment of hot gas and/or hot light gases.

The outflow of the gases is materialized through the nozzles (k) that can take different slopes related to the main body (a) (FIG. 1 & FIG. 5) on a radius level of symmetry of the main body (FIG. 2b). Thus they are able to change the direction of the force that is exercised on the outflowing point (the base of the nozzle mounted on the main body). Also by changing the pressure of the outflowing gas the meter of the foresaid force also changes proportionally. The nozzles are provided with gas through connoid tubes that are placed in the main body and are divided in subrooms. The volume of the subrooms from the first to the last is scalable decreased causing a scalable increment of the pressure of the gas as it flows between the subrooms from the first (δ₁—delta one) to the last (δₖ—delta kappa where kappa is a positive integer greater than ten). The connoid tubes are provided with gas by the rooms (4) where the atmospheric gas is consolidated by turbines that ingests it and divert it there. In case of an air pocket the nozzles are provided with gas from the Air Storage Tanks (from now on ASTs) (FIGS.1-7) which are tanks that store atmospheric air under really high pressure (liquidized).

The horizontal movement of airwheel in height ‘h’ (flight) is achieved by using a new technic of thrust through the rolling of the wheel. According to this technic by exercising a force (here this force is achieved by outflowing under great pressure gases) in the edge of the rolling wheel (b) (force's direction is opposite to the linear speed's direction of the edge) from a fixed point related to the main body of the vehicle we simulate the way a car moves by giving torsion from the engine to the wheel which through the braking force of the tire rolls instead of just rotating and thus moves the car.

In space airwheel takes advantage of the environmental magnetic fields created by the solar wind and the magnetosphere of the earth. Due to the magnetic fields of solar wind being extremely weak it extends telescopic devices from the tubelike stands that mount rolling wheel (b) to the main body to get the torsion the rolling wheel needs. These devices extend and open creating a ‘T’ in which upper part are located pairs of superconductor bobbins located in such a way that the magnetic field of each bobbin of the pair is opposite oriented to the other's. By taking advantage of the interaction between the magnetic field the bobbins create and the environmental magnetic field the rolling wheel as it rolls takes the torsion it needs to simulate the rolling of the wheel of a car, as it was mentioned before.

Airwheel is comprised by three constitutional units and these are:

The main body (a)

The rolling wheel (b)

The AMM (Angular Momentum Maintenance) Wheel (c)

The airwheel is seen as a whole structure in FIG. 5 where we can see in crosscut each of the foresaid structural units.

The Advantages of this Invention Connected with the Lift of the Disadvantages of the Prior State of Art Flying Vehicles.

Airwheel as disclosed before has the following advantages in relation to the prior state of art air vehicles.

Tremendous high speeds (due to the new technic of thrust via the rolling of the wheel) limited only by the durability of the materials the rolling wheel is constructed in distresses and the durability of the whole structure in high temperatures due to the frictions of the atmosphere on it. The prior state's of art air vehicles use the ‘pussing’ of gases to get their thrust and therefore the speeds they are able to achieve, are really low compared to airwheel's.

Increased stability due to the oposite rotating Rolling and AMM wheels (this is a basic principle of physics) and the use of the nozzles. The prior state's of art air vehicles are subject to flaws in the trajectory of flight due to side winds and air pockets.

Facing air pockets using gas stored in its air storage tanks (ASTs) as well as using the airbags (13) filled with hot air and/or hot light gases. The air vehicles of prior state of art use the Bernulli's principle to get their lift and therefore are subject to loss of lift in case of an air pocket.

Ability to change height and direction (chiming in the tremendous high speeds) in a real short period of time and in a very poky place with increased stability due to the nozzles talking different slopes related to the main body. The prior state's of art air vehicles are not able to do such a thing chiming in high speeds too.

Ability to land and take off vertical and in a real poky place with increased stability. From the prior state's of art air vehicles only helicopter is capable to do such a thing but when they are real close to the ground the stability is lesser than aliiwheel's

All these that were mentioned before are described graphically in the drawings that come with this patent request. A brief description of the drawings follows.

### BRIEF DESCRIPTION OF THE FIGURES IN DRAWINGS

FIG. 1—The main body of the airwheel

FIG. 2

FIG. 2a—A radial connoid tube with its nozzle

FIG. 2b—The movement of a nozzle in ground plan and side plan

FIG. 2c—Air Storage Tank (AST 1-upper AST or AST 2-lower AST)

FIG. 3

FIG. 3a—The rolling wheel in ground plan

FIG. 3b—Spiral device and outflowing device in zoom

FIG. 3c—The rolling wheel in crosscut in radius half plane

FIG. 4—The AMM wheel in ground plan and crosscut

FIG. 5—Airwheel as a whole structure in crosscut

FIG. 6

FIG. 6a—The foot of the airwheel extended and not

FIG. 6b—The telescopic device of the space air wheel

FIG. 6c—Pair of superconductor bobbins with their inner magnetic fields

FIG. 7—Showing of the way of turning (with angle degrees) using the rolling wheel (seen as a ring on the thinkable trigonometric circle).

FIG. 7a) Straight flight of the airwheel

FIG. 7b) Airwheel turns right

FIG. 7c) Airwheel turns left

FIG. 7d) The direction of flight is continuously identified with 90° & when it reaches the desired direction, the level where rolling wheel outflows becomes the one of 0°.

A detailed analysis of the materializing of the invention with use of examples from the drawings follows.

Detailed Analysis of the Materializing of the Invention with use of Examples from the Drawings

In order to make clearer how the airwheel is constructed the materializing of this invention is divided to the detailed analysis of materializing of each of the stuctural units of the airwheel. The analysis of the materialization (accompanied with the explanation of the role each of the parts included plays) starts with the main body and then goes to the materialization of the rolling & AMM wheels.

Materialization of the Main Body (a)

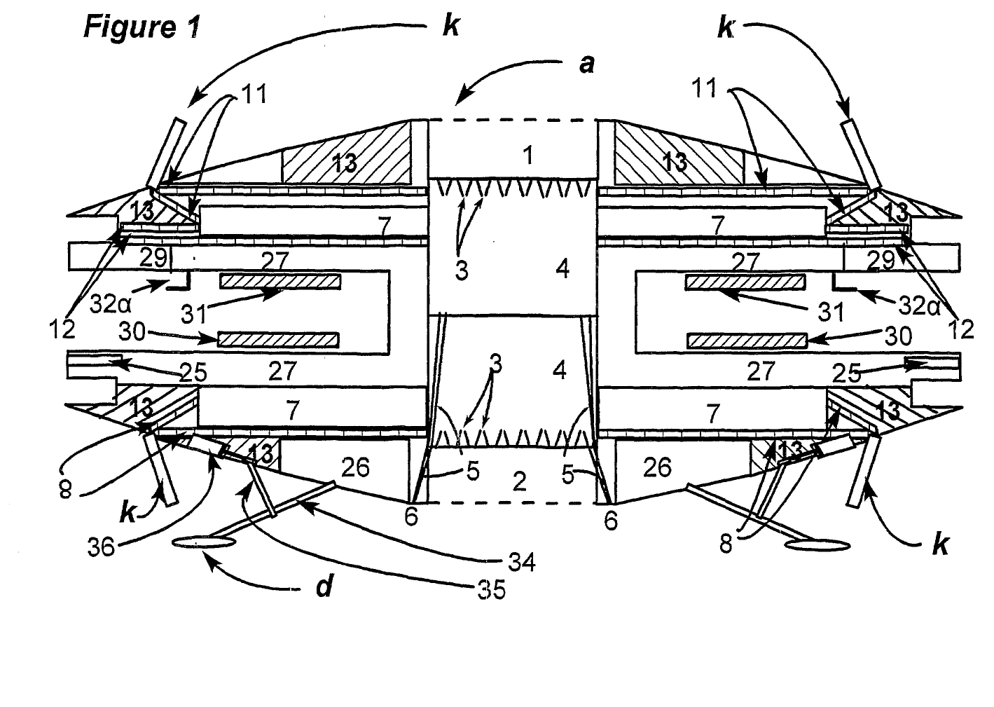

The main body in three dimentions has the same shape as a yo-yo as seen in FIG. 1 . It contains all the parts needed by airwheel to maintain its height of flight and some parts that support its horizontal movement (flight).

There are two accessions (1 & 2) in the main body, one in the upper side and one in the lower. Each of these accessions contains a turbine which ingests atmospheric air and diverts it to the rooms 4 through the funnels (3).

If it rains the turbines ingest water as well with the atmospheric gas. The water, as it is heavier, is consolidated in the lower palt of the room 4 and through connoid tubes is booted out with the help of pumps and outflows under great pressure from the small in diameter vents (6) in the lower part of the main body giving an extra lift to the whole structure.

The rooms 4 have some vents on their walls. These are the vents that provide with atmospheric gas the radial connoid tubes (FIGS.1-8,11,12) as well as the Air Storage Tanks (ASTs).

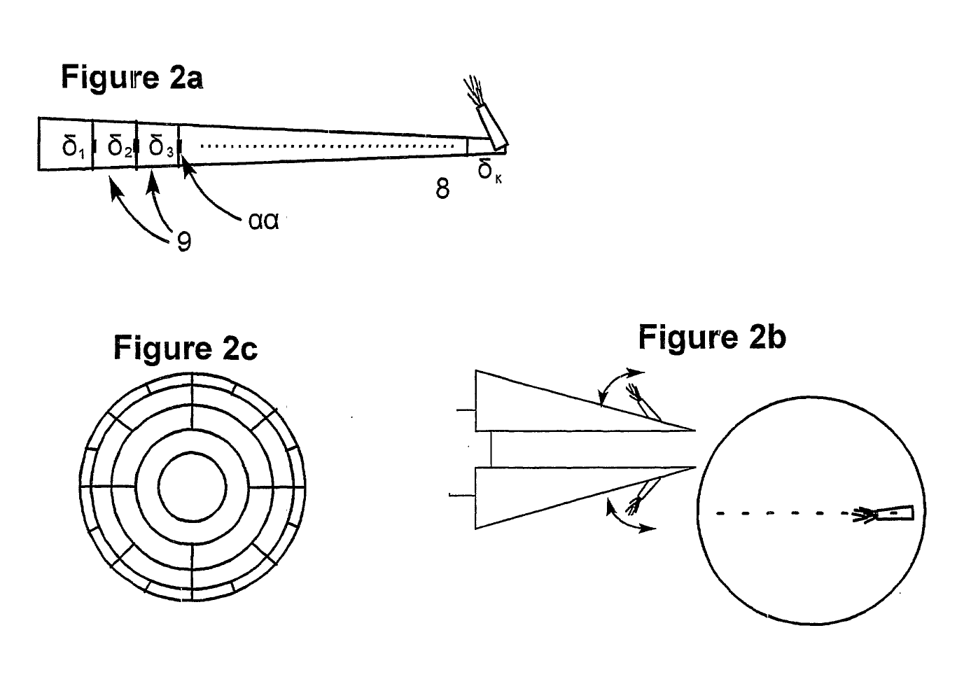

There are two kinds of connoid tubes. The ones that end up in nozzles and the ones that provide the rolling wheel with the gas it needs. The construction of both kinds of connoid tubes is the same and the only difference is that the last subroom of the first kind of connoid tubes is the nozzle. A connoid tube is a tube in the shape of cone with the top of the cone cut. It is subdivided in subrooms as seen (for the 1^{st} kind) in FIG. 2a. Each subroom has a smaller by a factor ‘n’ volume from the previous one (that's to say that V_{δ1}=n·V_{δ2} etc.). That decrement of the volume is accompanied by an increment of the pressure in every connoid tube from the second until the last by a factor ‘m’ (it would be the same factor ‘n’ for perfect gases but since the pressure is really high, quantum mechanics phenomena appear and the increment factor becomes ‘m’ which by suspicion might be close to ‘n’ but not exactly ‘n’). Thus, the nozzle outflows atmospheric gas in a pressure P_{noz}=Pₐₜₘ Π mᵢ (where Pₐₜₘ is the pressure of the atmospheric gas in the δ₁ (delta one) subroom and mᵢ is the increment factor of the pressure in every subroom from the second to the last related to the previous subroom's pressure). The second kind of connoid tubes (these that forward the gas to the rolling wheel) is built the same way with the exception that the last subroom won't be a nozzle but an open from the one side subroom and the pressure of the last subroom would be lower than the pressure of the last subroom of the first kind. It has to be highlighted that between the borders of two subrooms there will be devices (air compressors) that will forward the gas to the next sub room.

To sum up the 1^{st} kind of the connoid tubes (FIGS.1-8,11) will take atmospheric gas from the rooms (4) and forward it -increasing the same time the pressure of the gas to the nozzle where it will outflow under the foresaid pressure (P_{noz}). The 2^{nd} type of connoid tubes (FIGS.1-12) will take atmospheric gas from the rooms (4) and forward it to the rolling wheel increasing the same time the pressure of the gas in a lower level than before.

The rooms 4 also provide with atmospheric gas the ASTs . The ASTs (7) are tanks where airwheel stores gas in order to use it in case of an air pocket. The ASTs (FIG. 2c) are divided in concentric ringlike subrooms with decreasing volume from the first (near room 4) to the last (in the border of the AST). The decrement of the volume between two neighboring subrooms is given by the factor ‘n’ which gives the result of the volume of the outer subroom divided by the volume of the inner subroom. The increment of the pressure is given again by the factor ‘m’ as before (in the connoid tubes) due to the quantum mechanics phenomena that appear (due to high pressure). Still to make sure there will be enough gas in case of an air pocket all the subrooms except from the first will be fully filled with gas (fully means that the gas will be stored in such a pressure that won't cause the damage of the AST—the gas will be liquidized). In every subroom except the first, there will be partings (FIG. 2c) which will subdivide every subroom to sub-subrooms in order to make the flow of the gas between subrooms easier. The connoid tubes that start from the ASTs and end up in the nozzles or the upper ‘snag’ of the rolling wheel are the same as before but the pressure of the first subroom will be already high because it will get its gas from an already under high pressure fully filled with gas department.

The ASTs and the connoid tubes are two of the three devices which will make sure airwheel will fly. The third device is a set of airbags (FIGS.1-13) filled with hot atmospheric gas and/or hot light gases in order to decrease the total weight of the airwheel. This will male it easier to the nozzles to lift to a height ‘h’ and keep there the airwheel during the flight.

In the main body there will be also contained the lasers (FIGS.1-25). There will be 72 lasers located as seen in FIG. 1, one every five degrees. That's to say that the angle between the axes of two neighboring lasers will be 5° (angle degrees). The lasers will define the ‘level’ where the rolling wheel will outflow. To understand the formation of the lasers better see the seconds in a non-digital watch and mentally replace the seconds with lasers.

In the main body are also contained the rooms 26,27 & 29. The room 26 is a ringlike room which will contain the fuels (if internal combustion engines are used) or batteries/electric generators (if electric engines are used). The room 27 will be used for the engines which in case of internal combustion engines will take air from the upper room 4 and outflow the exhausts in lower room 4. In case of electrical engines it will take the energy need from the batteries/generators in room as mentioned before. There could by hybrid engines which they use internal combustion engines used in slow speed to provide mechanical energy to electric generators which will give the energy needed to electrical engines.

The room 29 will be used for carrying baggage and merchandise by 60% and by 40% to carry compressed atmospheric air needed for breathing.

The engines will give torsion to a gearbox device, which will give the torsion needed to a formation of six gears located on the tops of an hexagon. These gears will give motion to the rolling & the AMM wheels (six gears per wheel) as seen in FIG. 1 (31 & 31). The gears 30 will give torsion to the AMM wheel & the gears 31 will give torsion to the rolling wheel.

In case of airwheel being used as a space vehicle the lowest airbags 13 (seen in FIG. 1 behind the pistons (36) will be replaced by a ringlike tank (28) which will contain a liquid easily volatilizable (the use of this tank will be explained in The airwheel as a space vehicle paragraph). Also the room 29 will be used by 100% for storing compressed atmospheric gas for breathing.

In the lower side of the upper part of the main body we can see the stands which hold the AMM wheel.

In the lower side of the lower part of the main body we can see the landing device, which is a formation of six foots (a) extending when airwheel lands. The foot consists of three structural units which are: the piston (36), the supporting device (35) and the main foot (34). The main foot is steady mounted on the one side as seen in FIG. 1. The supporting device is mounted on the one side on a sliding device which slides on a driver steady mounted on a piece of the shell and on the other side the supporting device is mounted on the main foot (in the ⅗ of the main foot's length). The piston (FIGS.1-36) is used to puss the sliding part of the supporting device in order to extend the foot. When the opposite procedure occurs (the foot is retracted) the piston empties from air and is pulled mechanically back pulling the sliding part of the supporting device and thus pulling the main foot up. When the foot is up, a sliding cover covers the entire device and gives to the lower side of the lower part of the main body the cylindrical symmetry (cylindrical symmetry with the mathematical meaning). The piston gets the air it needs from the lower AST. The feet are also used as shock absorbers when the airwheel lands.

Materialization of the Rolling Wheel (b)

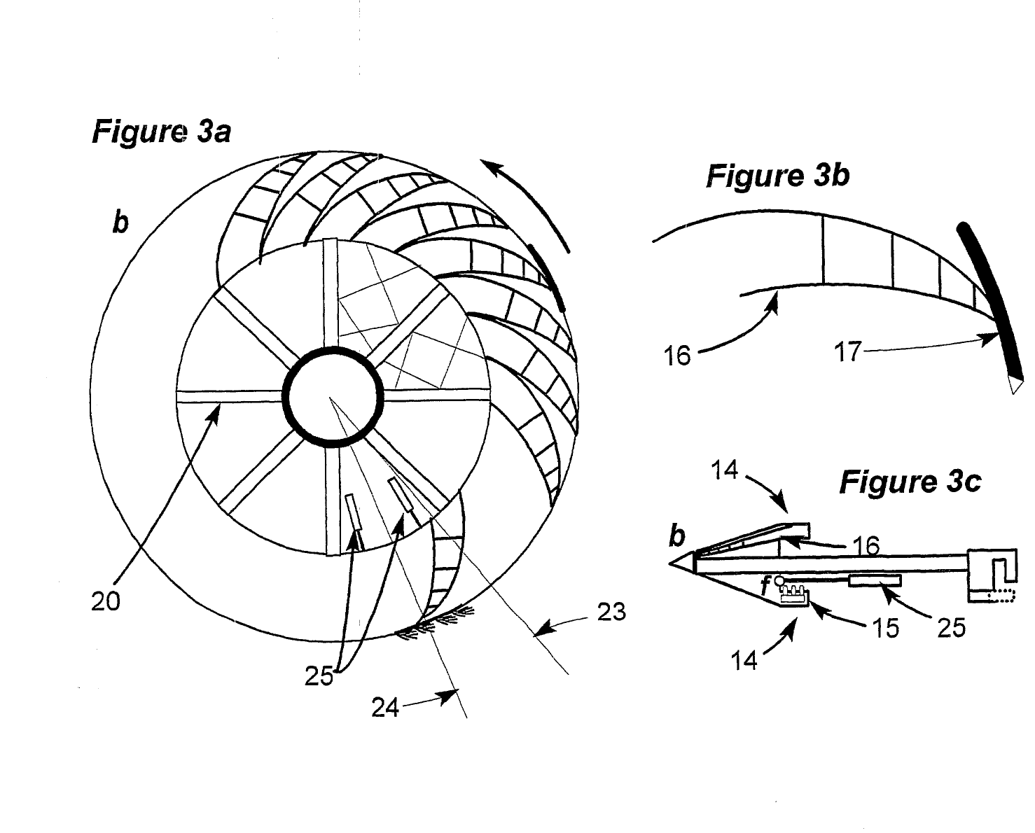

The rolling wheel is the structural unit of the airwheel, which is responsible for the horizontal movement in height ‘h’ (flight) of the whole structure. It is shown in FIG. 3a in ground ‘ghost’ plan. The rolling wheel consists of three structural units which are : the inner part (shown in highlighted black line in FIG. 3a), the tubelike stands (FIGS.3a-20) and the outer part as seen in FIG. 3a.

The inner part is the device that sets up the rolling wheel on the corresponding stands (rails) of the main body. As seen in FIG. 3c the inner part hangs on the rail and then a sliding part comes out and locks the inner part on the rail. The outer side of the inner part (left of the sliding part—FIG. 3c) has a surface which looks like a gear in order to take torsion from the gears (30).

The tubelike stands (20) mount the outer part on the inner part. These stands are mounted to each other for greater stability with crossed stands as seen in FIG. 3a (in FIG. 3a the crossed stands are seen only between three tubelike stands but all the tubelike stands are mounted to each other with crossed stands). In the space airwheel, the tubelike stands wilt contain telescopic devices which extend (the use of these devices is explained later in ‘The airwheel as a space vehicle’ paragraph).

The outer part of the airwheel is the part that is used for rolling. The rolling wheel as seen in cross cut (in a half plane starting with the axis of synmmetry of the rolling wheel) shows in cross cut the outer part. We can see the ‘snags’ (14) which mount the rolling wheel on the accessions of the main body (where the connoid tubes 12 end—FIG. 1), the sensors (f) and the electrical generators (15) in the lower ‘snag’ which give to the rolling wheel the needed energy to perform its function. The crosscut of the outflow device (17) can also be seen in FIG. 3c as a triangle (under the “b” without a number).

The outer part of the rolling wheel contains the spiral devices (16) which are spiral connoid tubes divided in subrooms (as seen in zoom in FIG. 3b). Their shape is spiral because this shape combined with the rotation of the rolling wheel subserves the ingestion of the gas provided by the connoid tubes (12) of the main body. The volume of the subrooms follows the same rule as the volume of the connoid tubes' subrooms increasing that way the pressure until the outflow device. The outflow device (17) has nozzles steady mounted, connected each with a corresponding sensor (f). When the sensor passes (as seen in FIG. 3a) in front of a laser beam the nozzle starts outflowing and when it passes in front of a second laser beam it stops. The direction the nozzles of the outflow device (17) outflow, is the same with the linear speed's direction of the edge of the outflow device (the edge of the rolling wheel) creating that way an opposite direction force which will simulate as mentioned before the braking force of the tire causing the rolling of it and through this the horizontal movement of the car. The two lasers (25) define a level (24) (actually an angle) in which the nozzles of the outflow device outflow. Lighting up different lasers we change this level causing the airwheel to turn. If we identify the level (23) with the direction of flight and light up the right lasers making the level (24) exactly the same with level (23) then airwheel will turn smoothly to the left as described in ‘An imaginable flight of the airwheel in Earth's atmosphere’ paragraph.

The Materialization of the Angular Momentum Maintenance (AMM) Wheel (c)

The AMM Wheel is a high inertia torsion wheel that rotates opposite to the rolling wheel's rotation to maintain the angular momentum of the whole structure constant equal to zero.

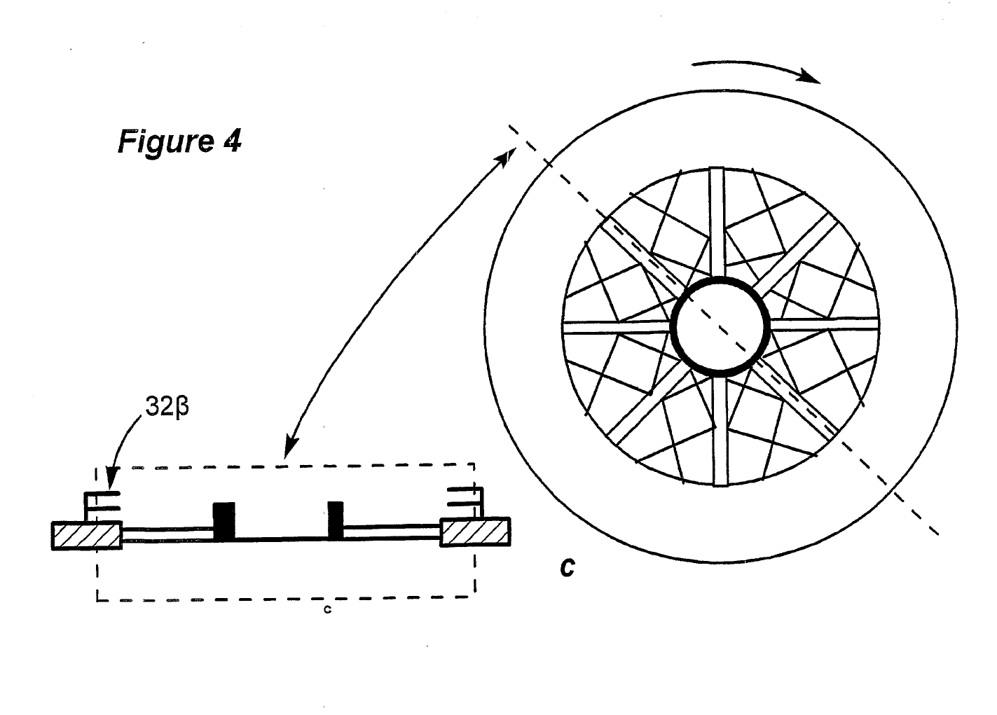

It is shown in FIG. 4. The discontinuous line in the ground plan identifies with a level of symmetry seen in the lower left as side plan.

The materialization of the AMM wheel is really simple. It consists of three structural units which are : the inner part, the tubelike stands and the outer part.

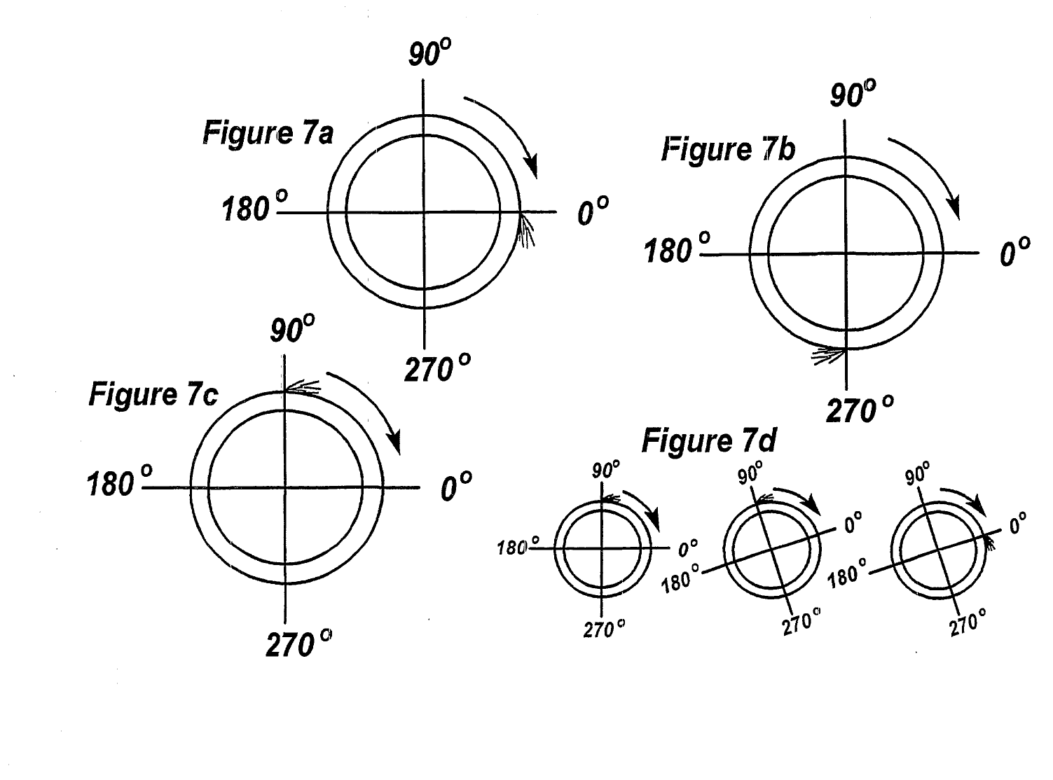

The inner part is the same as before with the exception that the gear-like surface is located on the upper vertical surface of the outer side of the inner part (right over the mounting of the tubelike stands on the inner part). That way the AMM wheel gets its torsion from the gears 31 (FIGS.7^{a}-31).

The tubelike stands that mount the outer part on the inner part are constructed this way for increased tensile strength.

The outer part is a high mass ring that is mounted on the inner part with the tubelike stands. Its specific angular speed rotation (opposite to the rolling wheel's) due to the high mass cancels the angular momentum of the rolling wheel and maintains that way the angular momentum of the whole structure constant equal to zero. As we can see in the side plan, in the upper side of the outer part are located the stands 32β (thirty two-beta) that hang the AMM wheel on the stands 32α (thirty two-alpha) of the main body.

The Airwheel as a Space Vehicle

In case airwheel is used as a space vehicle the materialization of the invention is almost the same but with two differences. The first is that the lowest airbags 13 next to the rooms 26 (see FIG. 1) are removed and a ringlike tank takes its place and the second is that in the tubelike stands that mount the outer part of the rolling wheel on the inner part, are contained telescopic devices.

The ringlike tank is fully filed with a liquid easily volatilizable. This liquid when the gas of the ASTs will be used, will be volatilized to fill again as more as possible the ASTs. The use of the ASTs in space as welt as the use of this ringlike tank is explained later in ‘The application of the invention in the industry’ paragraph.

The telescopic devices are used by airwheel to draft the torsion it needs to move in space. When airwheel is used in space, it will use the magnetic fields of the magnetosphere or the magnetic fields (from now on MFs) of solar wind which will interact with MFs it creates in order to draft the torsion the rolling wheel needs to roll (create a corresponding force to the braking force of a tire which makes the tire roll and not just rotate & thus moves the car).

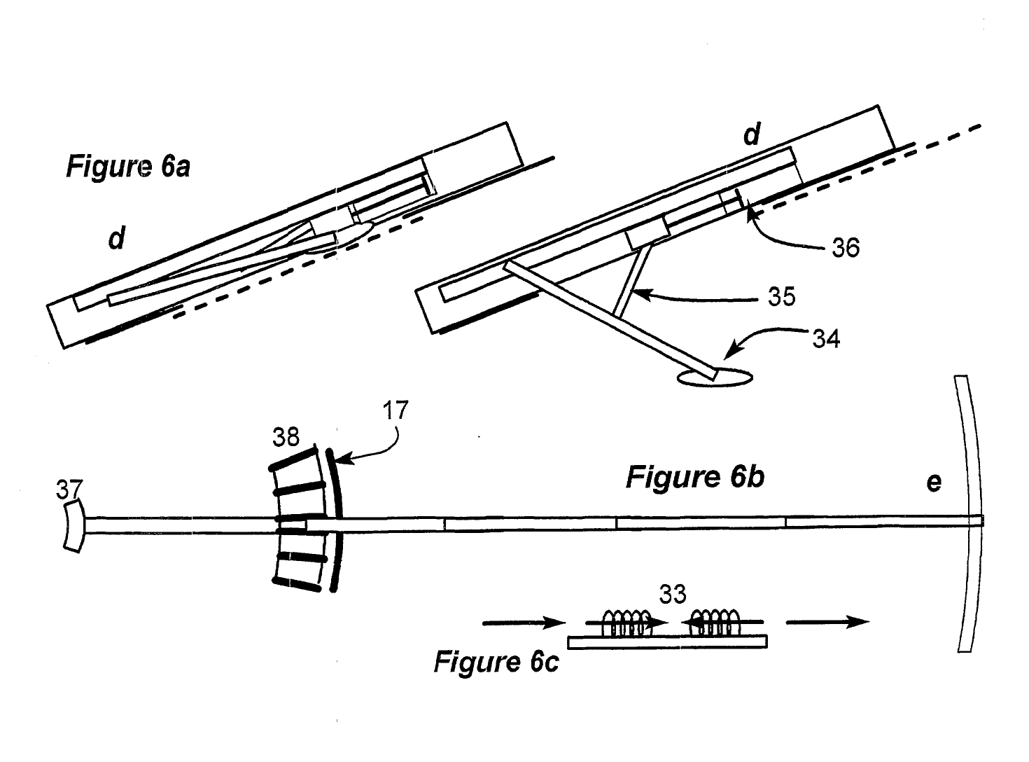

The interaction consists in pairs of superconductor bobbins with opposite directed inner MFs which interact with the environmental MFs (the MF of each bobbin is opposite directed to the MF of the other in each pair—see the vectors of the magnetic induction of the inner and the environmental MFs in FIG. 6c). The interaction occurs under the following principle. The poles of the magnetic fields are as seen further down (between the “|” are seen the poles of the bobbins' MFs in bold):

N|N S|S N|S

As we can make out each of the bobbins expels the other but they are steady mounted to each other. The formation of the poles causes the ‘push’ from the left and the ‘pull’ of the pair from the right (as seen here). There won't be any magnetic torsion because each time one pair of bobbins will be working and even though the magnetic energy of the left bobbin is higher than the one of right bobbin there won't be any torsion because the mass of the whole structure of the airwheel will prevent that (it will be impossible for the pair of bobbins to turn the whole airwheel from the torsion the pair gets from the environmental MFs).

The superconductors the bobbins are made of, will have unfold its superconductivity due to the temperature of the interplanetary space.

When airwheel leaves the atmosphere and gets in the magnetosphere the telescopic devices will extend from the tubelike stands of the rolling wheel as mentioned before and will open creating a ‘T’ (see FIG. 6b) in which top the pairs of the superconductor bobbins are located. The telescopic devices extend because the magnetic fields of the solar wind are extremely weak and by greatening its radius the airwheel will be capable of drafting the needed torsion from these weak magnetic fields. This might not be needed for use in the magnetosphere but this shall be decided by experimental measurements.

When the airwheel is used as a space vehicle it is launched from the earth before midnight to take advantage of the magnetosphere. In the magnetosphere airwheel will be using the outer regions of it (the magnetosphere) where there is not high energy hot plasma.

Application of the Invention in the Industry—A Detailed Analysis of How the Airwheel Will Work both in the Earth's Atmosphere and in Space

In the previous paragraphs, where the materialization of the invention was discussed, it was shown how the invention can be materialized and how each of the parts that are contained in the invention works. In the following paragraphs, it will, be described in every detail how the foresaid parts cooperate with each other to make the invention work. In order to do that, a detailed analysis of an imaginable flight both in atmosphere and in space will be made.

An Imaginable Flight of the Airwheel in Earth's Atmosphere

Airwheel is standing on the ground on its six feet (d) (FIG.6a) which are located on the lower side of the main body (a). The airbags (13) are fully filled with hot/atmospheric gas and/or hot light gases, decreasing that way the total weight of the airwheel and the tanks 26 are fully filled with fuels.

The airwheel engages the engines of the turbines in the accessions 1 & 2 and ingests that way atmospheric gas to the rooms 4 (upper & lower). The gases which are collected at this time in the rooms 4 are used to fully fill the ASTs.

When this is finished the airwheel engages the engines located in rooms 27 (see FIG. 1) and starts rotating the Rolling and AMM Wheels with the use of the gears 30 & 31. As it was mentioned before the rotation of each of the two wheels is opposite and equal (the angular momentum) to the other's to maintain that way the angular momentum of the whole structure.

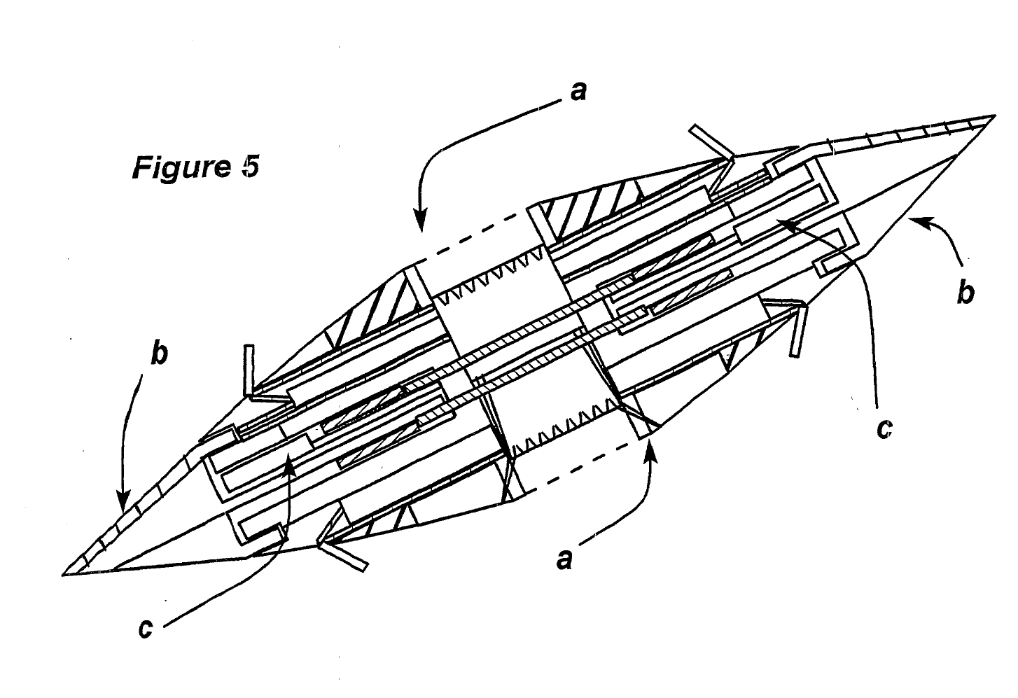

The gas is forwarded to the connoid tubes 8,11,12 from the rooms 4. For the case of 8,11 type connoid tubes the gas fully fills the connoid tubes until the nozzle which doesn't outflow at this time. For the case of 12 type connoid tubes the gas flows between the subrooms of the tube and outflows to the rolling wheel (see FIG. 1 & FIG. 5). The rolling wheel with its rotation and the shape of its spiral connoid tubes (16) is subserving the ‘sucking’ of the outflowing gas from the cornoid tubes 12. As the spiral devices (16) ‘suck’ the gas provided from the connoid tubes 12 they forward it between its subrooms until the outflowing device (17). The outflow device (17) doesn't outflow but is filled with gas under high pressure at this point.

The lower jets are pointed towards the ground-and start outflowing giving a vertical thrust to the airwheel which in conjuction with the decrement of airwheel's weight with the use of the airbags (13) it provides lift to the airwheel.

When the airwheel is on the air, it pulls its landing feet in the main body (a). The piston's container (36) will empty the air and the piston will be pulled back and pull that way the supporting device (35) which will pull inside the main body the foot (34).

After that airwheel will increase the pressure in the connoid tubes (8) & (11) and point the jets (k) (upper & lower) in a smaller slope related to the main body (a slope like the one in FIG. 1) creating that way an increased stability for the airwheel. It is obvious that the pressure in the lower jets will be higher than the one of the upper jets.

At this point the airwheel lights up two neightbouring lasers (25) which will define the area where the rolling wheel's outflow device (17) will outflow (FIG. 3a). This outflow will create a force which will simulate the braking force between the tyre of a car and the road and move that way the airwheel (i.e. the tyre gets torsion from the car's engine and through the braking force—friction—it doesn't just rotate but it rolls moving that way the car). The outflow from device (17) will occur only in the area that is defined by the two lasers (see FIG. 3a). When the jets of the outflow device (17) pass in front of the first laser the sensors (f) sense the light and the corresponding jets start outflowing and when the sensors (f) pass in front of the second laser the same way the corresponding jets stop outflowing. That way the airwheel will start ‘rolling’—flying in height ‘h’. If the pilot desires to increase the speed of the airwheel, he will increase the pressure in the connoid tubes 12 providing more gas to the rolling wheel (b). The rolling wheel (b) as well as the AMM wheel (c) will start rotating faster to maintain the angular momentum of the whole sturcture constant equal to zero. The increased flow of gases from the connoid tubes 12 will increase the pressure in the outflow device 17 which will outflow gases with greater pressure. That way it will increase the foresaid force (the one that simulates the friction) which will create an equal torsion to the increased one that the rolling wheel gets from the engines (it rotates faster) maintaining that way the rolling wheel to roll and not rotate faster than the thrust it gives to the airwheel. The condition for this to happen (maintain the rolling) is S=2πR, where ‘S’ is the distance the airwheel moves in one rotation of the rolling wheel whose radius is R.

Lets say now that the airwheel falls in an air pocket. The flow of atmospheric gases to the rooms 4 will decrease and the airwheel will sense that with sensors counting the mean pressure in the rooms 4. It will continue forward this gas to the connoid tubes 8,11,12 but will forward the same time to the foresaid connoid tubes the saved air in the ASTs to maintain a constant flight. By the time it passes the air pocket it will fill again the ASTs with a gas-flow rate that won't obstruct the constant flight of the airwheel.

If the airwheel wishes to turn there are two ways to do it. If its speed is low it can use the jets which will be properly pointed and by outflowing will cause airwheel to turn. If its speed is high then the following procedure will be followed:

Lets imagine an imaginable trigonometric circle (FIG.7a). The direction of flight is identified with the 90° point, the point where the rolling wheel outflow is identified with the 0° point (it outflows vertical to the 0° axis as seen in FIG. 7a) and at last the rolling wheel rotates with direction from 90° to 0°.

If the airwheel wishes to turn right, it will light up the proper lasers (25) so that the outflowing point will be identified with the 270° point as seen in FIG. 7b. This will make the airwheel start turning right. As it turns right we constantly identify the direction of flight with the 90° point of the trigonometric circle as well as the outflowing point with 270° point. This means that as it turns right the outflowing point of the rolling wheel keeps changing so that it is constantly identified with the 270° point of the imaginable trigonometric circle (the direction of flight is constantly identified as foresaid with the 90° point). When airwheel reaches the desired direction of flight, the outflowing point becomes again the 0° point in the imaginable trigonometric circle.

If the airwheel wishes to turn left, it will light up the proper lasers (25) so that the outflowing point will be identified with the 90° point as seen in FIG. 7c. This will make the airwheel start turning left. As it turns left we constantly identify the direction of flight with the 90° point (FIG.7d) of the trigonometric circle as well as the outflowing point with 90° point (it outflows vertical to the axis of 90° as seen in FIG. 7c). This means that as it turns left the outflowing point of the rolling wheel keeps changing so that it is constantly identified with the 90° level of the imaginable trigonometric circle (the direction of flight is constantly identified as foresaid with the 90° point). When airwheel reaches the desired direction of flight, the outflowing point becomes again the 0° point in the imaginable trigonometric circle.

The foresaid procedure will be followed if the airwheel wishes to turn in a ‘smooth’ way under high speed flight. If it doesn't wish to turn in a ‘smooth’ way, it can., also turn (under high speed flight) by pointing its jets properly and by ordering them to outflow, turn in a less ‘gliding’ way causing an extreme distress of G's to the passengers as a result.

Now when airwheel reaches close enough to its destination it stops providing gas to the rolling wheel which keeps rotating in order to maintain the steady (in slope) flight as well as to maintain the angular momentum of the whole structure (the AMM wheel keeps rotating too). The airwheel as it gets no thrust from the rolling wheel starts braking aerodynamically reducing little by little its speed. When airwheel is really close to the landing site it points all its jets in such a way so that the vertical components of the forces created by the jets are the same as before but the horizontal are opposite to the direction of flight. When it stops in the air exactly over the landing site it lands vertically with the exactly oposite procedure of its take off.

Description of Airwheel's Function in Space

The procedure of take off is the same with the take off of the flight in the Earth's atmosphere and so is the flight itself in the beggining. The ASTs are fully filled once again with gas and so is the tank 28 (seen as the lowest devices 13 in FIG. 1) filly filled with a liquid easy to volatilize. During the flight at a certain time the jets are pointed in such a way that turn the airwheel upwards and provide him with lift in that upgoing flight.

(in FIG. 5 if we draw an imaginable horizontal line parallel to the higher dimension of the sheet—the line represents the horizon—we get an idea of the airwheel's flight at this point which will be towards the upper right corner of the sheet as we look at it in ‘landscape’).

The rolling wheel will start rotating faster giving the airwheel an extra thrust which accelerates it. In a height ‘h’ the airwheel will have accomplish a high speed, enough to get it out of the Earth's gravity to the interplanetary space. This procedure will always occure some hour before midnight in order to take advantage of the earth's magnetotail.

When airwheel is high enough where the atmosphere is not that dense it will extend its T-like telescopic devices (e) as seen in FIG. 6b. Using these T-like devices airwheel will get the desired force to roll from the reaction between the magnetic fields of the magnetosphere and the fields that they create (with the opposite directed bobbins on the upper part of the T-like telescopic devices).

Airwheel will follow the magnetic lines of the Earth's magnetosphere and then get out of it and follow the magnetic lines of the magnetotail. Following the magnetotail it will get out of it and then follow the magnetic fields of the solar wind. Although solar wind's fields are really weak the combination of the high magnetic fields the T-like devices create with the length itself of these T-like devices should be capable to counterbalance the torsion that the rolling wheel gets from the engines. The engines will be electroengines powered by nuclear energy.

When airwheel will arrive in the destination planet it will use some of the gas saved in the ASTs to brake itself and get a proper slope for the insertion in the planet's atmosphere. The slope must be the one that will not let the airwheel leave from the attraction of the planet's gravitational field and will not make the airwheel burn by entering with high speed in the planet's atmosphere under a great slope which will accelerate the vehicle more. Under the right slope the airwheel will get into the planet's atmosphere and will aerodynamically brake approaching the ground in a spiral way.

Aproaching that way the ground, airwheel will land smoothly using the atmosphere and the rest gas of the ASTs (which will be heated to increase its pressure). It may also use parasutes and airbags.

When airwheel will leave the planet, the take off procedure is exactly the same with the take off from the earth. It will fully fill the ASTs and then take off. If the atmosphere is not dense enough to use it the airwheel will use some of the gas of the ASTs too. During the interplanetary flight the airwheel will volatilize the liquid contained in the tank 28 (seen as the lowest devices 13 in FIG. 1) and fill again as enough as possible the ASTs. During the returning flight the polarity of the bobbins of the T-like devices will be inverted. The landing on the earth procedure will be exactly the same with the landing on the destination planet procedure but this time airwheel will use mainly the atmospheric gas to land.

It has to come under notice that during the interplanetary flight (going or returning), when the airwheel will use the solar wind's magnetic fields, the polarity of the bobbins of the T-like devices will be inverted as the airwheel will pass from territory to territory with oposite directed magnetic fields in each territory so that the reaction of the external (environmental) and the internal (bobbin created) magnetic fields serves its needs better.

1. Flying disk shaped flying/space vehicle with the use of a new technic of thrust through the rolling of a wheel (from now on the vehicle will be referred as airwheel) which contains the main body (a) (FIG.1), a wheel that embraces it called rolling wheel (b) (FIG.3) which is used through its rolling for the (new technic of) thrust of the airwheel and a third wheel called Angular Momentum Maintenance wheel (c) (FIG. 4) (from now on AMM wheel) which embraces the center part of the main body, is located inner than the rolling wheel and rolls the other way around to maintain the angular momentum of the whole construction constant equal to zero. Airwheel is characterized by a new technic of thrust through the rolling of a wheel. This new technic is based on the theory of the rolling of a wheel as described in physics and it materializes by exercising a force in the edge of the rolling wheel (b) (directed to the same direction as the linear speed of the edge) from a fixed point related to the main body of the airwheel and simulating like that the way a car moves by giving torsion from the engine to the wheel which through the braking force of the tire rolls instead of just revolving.

2. Flying disk shaped flying/space vehicle with the use of a new technic of thrust through the rolling of a wheel (from now the vehicle will be referred as airwheel) which introduces a new technic of thrust as referred in claim #1 which technic is characterized by the fact that the thrust of a flying vehicle can be achived by the rolling of a wheel. This shall be done by exercising a force (here this force is achieved by outflowing under great pressure gases) in the edge of the rolling wheel (b) (force's direction is opposite to the linear speed's direction of the edge) from a fixed point related to the main body of the vehicle and simulating like that the way a car moves by giving torsion from the engine to the wheel which through the braking force of the tire rolls instead of just revolving and thus moves the car.

3. Flying disk shaped flying/space vehicle with the use of a new technic of thrust through the rolling of a wheel (from now the vehicle will be referred as airwheel) whose main body as referred in claim #1 is shown in FIG.1 and has two receptions in the edges of the upper and lower part of the main body (FIGS.7-18 & FIG. 5) where the ‘snags’ of the rolling wheel are mounted. In the upper and in the lower part of the main body there are two accessions (FIGS.1-1,2) which are covered by grids (FIG.7b) and each one contains a turbine which ingests atmospheric air and diverts it to rooms 4 (upper and lower—FIGS. 1-4 & FIGS. 7a-4) (FIGS.1-3). These rooms have holes which provide with gas the connoid tubes (devices that contain subrooms and increase piecemeal—subroom by subroom—the pressure of the gas until the nozzles FIG. 1-8,11 or the rolling wheel FIGS. 1-12). The main body also contains the Air Storage Tanks (from now on AST FIGS. 1-7) which are torroid (shaped like mathematical torus) rooms in which air is stored under great pressure in order to be provided to the nozzles and the rolling wheel in case of an air pocket. There are two sets of 12 nozzles on the upper and on the lower surface (each dozen) and the nozzles can take different slopes related to the main body and outflow gas under different pressure exercising that way in the outflowing point different in meter and direction force. In the main body are also contained the devices 13 (FIGS.1-13) which are airbags containing hot atmospheric gas and/or hot light gases and are used to decrease the total weight of the airwheel. The main body also contains 72 lasers which are symmetrical shared per 5° and are used (two of them) to define the area where the rolling wheel will outflow creating the needed force to roll. In the main body there are also rooms for the engines (FIGS.1-27) (internal combustion or electric) and rooms for the fuels (FIGS.1-26) (or batteries—electric generators in case of electric engines). There are also in the main body the landing devices (d) which are six feet extending from the lower part of the main body.

4. Flying disk shaped flying/space vehicle with the use of a new technic of thrust through the rolling of a wheel (from now the vehicle will be referred as airwheel) whose main body (c) contains connoid tubes (FIGS.1-8,11,12) as referred in the claim #3 . These tubes are divided in subrooms of scalable decreased volume by a factor ‘n’ (FIG.2a) and therefore there is a scalable increased by the same factor pressure—subroom by subroom—till we get to the end of the tube where the gas outflows under great pressure to the nozzles or towards the inner side of the rolling wheel (b). If the factor of volume decrement is not constant but different in each next subroom (let's say nᵢ) the pressure of the outflowing gas will be Pₗₐₛₜ=Pₐₜₘ·The connoid tubes that are provided with gas by the ASTs (as referred in claim #3) are the same as the ones that are provided with gas by the rooms 4.

5. Flying disk shaped flying/space vehicle with the use of a new technic of thrust through the rolling of a wheel (from now the vehicle will be referred as airwheel) whose main body contains Air Storage Tanks (ASTs) as referred in claim #3. The ASTs are used by airwheel in case of an air pocket occurrence or by the space airwheel for the landing on the destination planet. Each AST will comprise of by concentric torroid rooms (FIG.2b). Between each pair of neighboring torroid rooms the volume will be decreased by a factor ‘n’ and therefore there will be a same factor increment of the pressure. Yet the ASTs would be fully filled by gas with the same pressure in each room in order to be able to cover the needs of the airwheel in gas in every case. All the torroid rooms except from the first will be divided in subrooms by partitions located according to the distance from the first subroom equally per 90°, 45°, 22,5° etc to make the flow of the gas to every next subroom easier.

6. Flying disk shaped flying/space vehicle with the use of a new technic of thrust through the rolling of a wheel (from now the vehicle will be referred as airwheel) whose outer wheel—the rolling wheel (b)—as referred in claim #1 will be the device of the airwheel which will be responsible for the horizontal movement of the vehicle in height ‘h’ (flight). The rolling wheel (FIG.3a) is characterized by spiral connoid tubes (FIGS.3-16) which will be devided in subrooms of scalable decreasing volume until the outflowing device 17 (FIGS.3-17). This device will outflow gas from a fixed point (related to the main body (a)) of the edge of the rolling wheel in the same direction as the direction of the linear speed of the edge of the rolling wheel creating that way an opposite direction force and through it will roll. The rolling wheel also contains the sensors f (FIG.3-f) which sense a laser beam and ‘order’ the corresponding nozzle to outflow or stop outflowing (when they pass in front of a second laser beam). In the upper ‘snag’ of the rolling wheel are contained electric generators, which through the rolling of the wheel produce the needed energy to provide to the rolling wheel. In the space airwheel there will be telescopic devices in the tubelike stands which mount the rolling wheel on the main body. The telescopic devices will extend to increase the effective radius of the rolling wheel (as effective radius is defined the radius that is able to create the needed trend which will oppose to the trend the rolling wheel gets from the engine of the airwheel)

7. Flying disk shaped flying/space vehicle with the use of a new technic of thrust through the rolling of a wheel (from now the vehicle will be referred as airwheel) which will contain in the tubelike stands of the rolling wheel telescopic devices as referred in claim #6 if it is used as a space vehicle. These will extend when the airwheel gets out of the atmosphere and gets in the magnetosphere and will open (FIG.6c) creating a ‘T’ in which T's upper part there will be pairs of superconductors bobbins whose their inner magnetic field (the m.f. of cach bobbin of the pair) will be opposite oriented (see the vectors of the magnetic inductions in FIG. 6c). The reaction of the magnetic field of the bobbins and the environmental magnetic field will create the needed force to materialize the new technic of thrust as described in claim #2.

8. Flying disk shaped flying/space vehicle with the use of a new technic of thrust through the rolling of a wheel (from now the vehicle will be referred as airwheel) whose main body will have landing devices (d) (FIG. 1 & FIG. 6a-d) as referred in claim #3. These devises will be six feet that will be contained in the lower part of the main body. Each foot will be comprised by the main foot (the part that will come down and touch the ground), the supporting part (the part which will support the main foot) and the piston which will push the supporting device and get the foot down that way. The main foot (FIGS.1-34) will be steady mounted on the one side and will be movable on the other. Its movement will be done on a radius level of symmetry of the main body and it will ‘scan’ this level rotating around the steady mounted side. The supporting device (FIGS.1-35) will be steady mounted on the main foot on the one side and will slide on a driver located on a part of the shell of the main body from the other side The piston (FIGS.1-36) will push through the pressure of the gasses (the gasses will be provided to the piston by the lower AST) the sliding part of the supporting device getting down the main foot. When the foot needs to come up the sliding part of the supporting device will be pulled mechanically pulling up the main foot. When the foot is up it will be covered by a sliding cover.
